(19) United States
(12) Patent Application Publication
(10) Pub. No.: US 2021/0235713 A1
(43) Pub. Date: Aug. 5, 2021

(54) PROCESS FOR EXTENDING THE STORAGE STABILITY OF CHOPPED FRESH PARSLEY

(71) Applicant: Brandon Bahoura, Clarkston, MI (US)

(72) Inventor: Brandon Bahoura, Clarkston, MI (US)

(21) Appl. No.: 17/162,123

(22) Filed: Jan. 29, 2021

Related U.S. Application Data
(60) Provisional application No. 62/968,497, filed on Jan. 31, 2020.

(51) Int. Cl. A23B 7/154; A23L 3/3472; A23L 19/00

(52) U.S. Cl. CPC A23B 7/154; A23L 3/3472; A23V 2002/00; A23L 19/03; A23L 19/01

(57) ABSTRACT

A method for preserving chopped fresh parsley and extending the storage stability thereof through an admixture of chopped fresh parsley and dried mint, dried parsley, or a combination thereof. The intermixing of chopped fresh parsley with dried mint, dried oregano, or a combination thereof is in the absence of thermal and chemical adulterants, where absorbing moisture released from the chopped fresh parsley is with the dried mint, dried oregano, or a combination thereof such that the water activity of the mixture is less than 0.90, thereby inhibiting microbial growth, enzymatic browning, or a combination thereof, and extending the storage stability of the chopped fresh parsley to at least 48 hours at a temperature range of 33° F. to 75° F. When included in a tabbouleh salad dish, the resultant mixture extends the storage stability of the tabbouleh salad to at least 48 hours to beyond 72 hours.

### CROSS REFERENCE TO RELATED APPLICATIONS

This application claims priority benefit of U.S. Provisional Application Ser. No. 62/968,497 filed 31 Jan. 2020, the contents of which are hereby incorporated by reference.

### FIELD OF THE INVENTION

The present invention in general relates to a process for preserving fresh plant material, and in particular, to a process for preserving chopped fresh parsley with dried mint, dried oregano, or a combination thereof.

### BACKGROUND OF THE INVENTION

Plant materials, illustratively including fruits, vegetables, herbs, and spices, are an integral part of the human diet. Fresh plant materials are particularly desirable as their flavor profiles, textures, colors aromas, and nutritional content are often most robust in a fresh state. Unfortunately, fresh plant materials degrade rapidly, often spoiling within days or even hours. The limited storage stability of fresh plant materials has a variety of negative consequences illustratively including: waste as the fresh plant materials spoil before they can be consumed; loss of enjoyment as fresh plant materials are often consumed past their peak freshness, thus having lost their desirable flavor, texture, color, and aroma profiles; reduction of nutritional benefit as valuable nutrients are lost during degradation of plant materials; and even risk of food borne illness as the proliferation of bacteria, fungus, and other microbes increases as plant materials degrade.

Fresh herbs are particularly prone to rapid spoilage. Preparation of fresh herbs for consumption damages plant tissues, thereby releasing browning enzymes that catalyze deterioration reactions which disrupt cell structure causing rapid loss of fresh herbs' desirable color, texture, flavor, smell, and nutritional content. By way of example, chopped fresh parsley discolors, turns soft and slimy, and loses flavor within hours. This presents a challenge for those who enjoy dishes including parsley, illustratively tabbouleh salad which is a parsley-based salad dish of Middle Eastern origin that also traditionally includes bulgar, tomatoes, mint, onion, olive oil, lemon juice, salt, and pepper. While the other constituents of tabbouleh salad may be storage stable for days, the entire dish spoils within hours as its edibility is limited by the very short storage stability of the chopped fresh parsley, which taints the entire dish upon spoilage.

Effective preservation of fresh plant materials has been a desirable yet formidable endeavor for millennia. While a multitude of preservation compositions and methods are well known in the art, the desirable characteristics of fresh plant materials, illustratively including their robust flavor profiles, textures, colors, aromas, and nutritional content are almost always negatively affected by known preservation compositions and methods. Many known preservation compositions and methods rely on the use of a variety of thermal and chemical adulterants illustratively including heating, freezing, drying, adding oils, salts, chemical oxygen scavengers, chemical desiccants, chemical wetting agents, and the like in order to achieve extended preservation and storage stability of plant materials. Such adulterants often alter the desirable texture, color, aromatic, and flavor profiles of various plant materials. Nutritional value of preserved plant materials is also often compromised by known preservation compositions and methods. Thus, the nutritional value of preserved plant materials is often lower than the nutritional value of their fresh counterparts as many preservation adulterants either destroy nutrients within fresh plant material, and/or add chemicals of limited to no nutritional value illustratively including high fructose corn syrup. In addition to having limited to no nutritional value, some preservation adulterants may also be toxic or otherwise harmful to human health. With the significant lag time between introduction of potentially harmful preservation adulterants into the food stream and the collection of statistically significant long-term data reflecting a correlation between consumption of a harmful preservation adulterant and attendant negative health impacts, it is often too late to ameliorate the damage caused to an entire generation of the human population exposed to harmful preservation adulterants. This risk is not merely prophetic as a multitude of substances once considered safe for use as a food preservative are now banned by the FDA as toxic and/or otherwise harmful to human health. Additionally, many food preservative compositions and methods known in the art require the use of industrial technology or complex multi-stage treatments, preventing their widespread adoption for use in domestic culinary settings. The use of manufactured absorbent material, illustratively absorbent pads, to wick moisture away from fresh plant material is also known in the art but has proven less than effective.

CA3018327A1 discloses a method for preparing a ready to use storage stable food composition requiring the addition of an oil to fresh plant material, and rapidly heating and then cooling the mixture.

CA1115597A discloses a process for preserving fresh herbs requiring the addition of an edible oil and a wetting agent selected from low molecular weight soluble salts of an alkaline metal, alkyleneglycols, glycerols, and sugars.

AU2013203975A1 discloses a method for preserving plant material requiring applying a composition comprising a microwave attractant to plant material, and then drying the plant material while exposing the plant material to microwave energy, wherein the microwave energy heats the plant material to a temperature effective to inactivate the majority of browning enzymes in the plant material.

U.S. Pat. No. 5,397,584 discloses a process for preparing a frozen herb product requiring introducing the herb into an infusion bath comprising 10 to 70% by weight of an osmotic agent at a temperature of at least about 180 degrees Fahrenheit for a time sufficient to reduce the water activity coefficient of the herb to below about 0.97 and cause infusion of the osmotic agent into the herb and subsequently freezing the infused herb.

Various herb pastes and dehydrated plant material formulations are also well known in the art. An exemplary herb paste is detailed in U.S. Pat. No. 4,572,836 and an exemplary dehydrated plant material formulation is detailed in U.S. Pat. No. 3,917,857.

None of these or other known compositions or methods offer a simple preservation method that accomplishes the preservation and extended storage stability of fresh plant material, specifically fresh herbs, without the use of adulterants or manufactured absorbent material. More specifically, none of these aforementioned references, or other known compositions or methods offer a simple method for preserving fresh chopped parsley without the use of adulterants or manufactured absorbent material.

Thus, there exists a need for a simple method for preserving fresh chopped parsley and extending the storage stability thereof, without the use of adulterants or manufactured absorbent material.

### SUMMARY OF THE INVENTION

A method is provided for extending storage stability of chopped fresh parsley or tabbouleh salad. The method includes intermixing chopped fresh parsley or tabbouleh salad with dried mint, dried oregano, or a combination thereof, where a weight ratio of the dried mint, dried oregano, or a combination thereof to the chopped fresh parsley or tabbouleh salad being between 1:4 and 1:60 to form a mixture. Moisture released from the chopped fresh parsley is absorbed with the dried mint, dried oregano, or a combination thereof to extend the storage stability of the chopped fresh parsley or the tabbouleh salad to at least 48 hours at a temperature range of 33° F. to 75° F.

A composition is provided that includes chopped fresh parsley or tabbouleh salad having dried mint, dried oregano, or a combination thereof in a weight ratio of the dried mint, dried oregano, or a combination thereof to the chopped fresh parsley or tabbouleh salad of between 1:25 and 1:60 to form a mixture.

### DETAILED DESCRIPTION OF THE INVENTION

The present invention has utility as a process for preserving chopped fresh parsley and extending the storage stability thereof through the admixture of chopped fresh parsley and dried mint, dried parsley, or a combination thereof.

The present invention will now be described with reference to the following embodiments. As is apparent by these descriptions, this invention can be embodied in different forms and should not be construed as limited to the embodiments set forth herein. Rather, these embodiments are provided so that this disclosure will be thorough and complete, and will fully convey the scope of the invention to those skilled in the art. For example, features illustrated with respect to one embodiment can be incorporated into other embodiments, and features illustrated with respect to a particular embodiment may be deleted from the embodiment. In addition, numerous variations and additions to the embodiments suggested herein will be apparent to those skilled in the art in light of the instant disclosure, which do not depart from the instant invention. Hence, the following specification is intended to illustrate some particular embodiments of the invention, and not to exhaustively specify all permutations, combinations, and variations thereof.

Ranges provided herein are understood to be shorthand for all of the values within the range. For example, a range of 1 to 50 is understood to include any number, combination of numbers, or sub-range from the group consisting of 1, 2, 3, 4, 5, 6, 7, 8, 9, 10, 11, 12, 13, 14, 15, 16, 17, 18, 19, 20, 21, 22, 23, 24, 25, 26, 27, 28, 29, 30, 31, 32, 33, 34, 35, 36, 37, 38, 39, 40, 41, 42, 43, 44, 45, 46, 47, 48, 49, or 50, as well as all intervening decimal values between the aforementioned integers such as, for example, 1.1, 1.2, 1.3, 1.4, 1.5, 1.6, 1.7, 1.8, and 1.9. With respect to sub-ranges, “nested sub-ranges” that extend from either end point of the range are specifically contemplated. For example, a nested sub-range of an exemplary range of 1 to 50 may comprise 1 to 10, 1 to 20, 1 to 30, and 1 to 40 in one direction, or 50 to 40, 50 to 30, 50 to 20, and 50 to 10 in the other direction.

Unless otherwise defined, all technical and scientific terms used herein have the same meaning as commonly understood by one of ordinary skill in the art to which this invention belongs. The terminology used in the description of the invention herein is for the purpose of describing particular embodiments only and is not intended to be limiting of the invention.

Unless indicated otherwise, explicitly or by context, the following terms are used herein as set forth below.

As used in the description of the invention and the appended claims, the singular forms “a,” “an” and “the” are intended to include the plural forms as well, unless the context clearly indicates otherwise.

Also as used herein, “and/or” refers to and encompasses any and all possible combinations of one or more of the associated listed items, as well as the lack of combinations when interpreted in the alternative (“or”).

The suffix “(s)” as used herein is intended to include both the singular and the plural of the term that it modifies, thereby including one or more of that term.

Reference throughout the specification to “one embodiment”, “another embodiment”, “an embodiment”, and so forth, when present, means that a particular element (e.g., feature, structure, and/or characteristic) described in connection with the embodiment is included in at least one embodiment described herein, and may or may not be present in other embodiments. In addition, it is to be understood that the described elements may be combined in any suitable combination or configuration.

According to embodiments, an inventive process for preserving chopped fresh parsley includes intermixing chopped fresh parsley with dried mint, dried oregano, or a combination thereof in the absence of thermal and chemical adulterants, absorbing moisture released from the chopped fresh parsley with the dried mint, dried oregano, or a combination thereof such that the water activity of the mixture is less than 0.90, thereby inhibiting microbial growth, enzymatic browning, or a combination thereof, and extending the storage stability of the chopped fresh parsley to at least 48 hours at a temperature range of 33° F. to 75° F.

Chemical adulterants and processes not present in, or applied to an inventive composition illustratively include heating, freezing, drying, adding oils, salts, chemical oxygen scavengers, chemical desiccants, chemical wetting agents, and the like.

Water activity (A_{w}) is a measurement of the amount of water in a substance that is available to participate in chemical and biological processes. A_{w} is calculated by dividing the partial vapor pressure of water in a substance by the standard sate partial vapor pressure of water. In food science, the standard state partial vapor pressure is commonly defined as the partial vapor pressure of pure water at the same temperature. Using the food science definition, a common reference point is pure distilled water which has A_{w} of 1.0. Typically, plant material with higher A_{w} tends to spoil more quickly than plant material with a lower A_{w} owing to the existence of ample bioavailable water which allows for increased microbial growth and activity. As microbial load increases, fresh plant tissue becomes exposed to degradative biochemical processes and enzymes, thereby increasing the rate of plant material spoilage. Enzymatic degradation is also directly related to A_{w} as plant materials with higher A_{w} provide a rich source of molecular oxygen. Enzymatic browning is a virtually ubiquitous process that occurs in fresh foods, illustratively including plants and herbs. Enzymatic browning reactions cause degradation that ultimately leads to spoilage. Polyphenol oxidase (PPO) enzyme is a major enzyme responsible for browning reactions in vegetive material. When plant tissues are damaged (e.g., chopped), PPO activity increases, catalyzing enzymatic browning. PPO catalyzes two distinct reactions involving molecular oxygen: (i) the o-hydroxylation of monophenol and (ii) the oxidation of o-diphenol to o-quinones. The main step in enzymatic browning is the oxidation of phenolic compounds to corresponding quinones by PPO in the presence of oxygen. The quinones then polymerize to form dark pigments (Sakiroglu, H. et al., Some kinetic properties of polyphenol oxidase obtained from dill (Anethum graveolens), Journal of Enzyme Inhibition and Medicinal Chemistry, June 2008, pp. 380-385, 23(3)). Increased PPO activity also decreases levels of phenolic compounds present in fresh plant material (i.e., plant secondary metabolites with well documented nutraceutical properties) (Sikora, M. et al., Biochemical Properties of Polyphenol Oxidase from Ready-to-Eat Lentil (Lens culinaris Medik.) Sprouts and Factors Affecting Their Activities: A Search for Potent Tools Limiting Enzymatic Browning, May 7, 2019, pp. 1-10, vol. 8). Thus, reduction of A_{w} is of particular interest in the art of food preservation. Plant material having A_{w} of less than 0.90 is readily sufficient to inhibit microbial growth. At A_{w} between 0.65 and 0.85, microbial growth is further inhibited, and at A_{w} less than 0.65, microbial growth is virtually nonexistent as there is not enough bioavailable water for microbes to live. Enzymatic browning is stunted due to the lack of bioavailable molecular oxygen.

Chopped fresh parsley has a high A_{w} and thus a particularly poor storage stability. Owing to its high moisture content, chopped fresh parsley can spoil in as little as 2 hours. According to embodiments of the present invention, it has been unexpectedly discovered that intermixing chopped fresh parsley with dried mint, dried oregano, or combinations thereof reduces the A_{w} of the chopped fresh parsley. In some inventive embodiments, intermixing dried mint, dried oregano, or combinations thereof reduces the A_{w} to between 0.65 and 0.85. In other inventive embodiments, intermixing dried mint, dried oregano, or combinations thereof reduces the A_{w} to less than 0.65. The absorbent properties of dried mint and dried oregano are unexpectedly superior to alternative dried herbs as it would be expected that equal amounts of various dried herbs having similar texture and of similar particle size would all exhibit similar absorbent properties when intermixed with chopped parsley. However, as supported by the experimental data described in the examples to follow, dried mint and dried oregano exhibit superior absorbent properties relative to other herbs, illustratively including cilantro.

In embodiments of the present invention, significant extension of the storage stability of chopped fresh parsley has also been surprisingly achieved. In some inventive embodiments, the intermixing of dried mint, dried oregano, or combinations thereof increases the storage stability of chopped fresh parsley to at least 48 hours at a temperature range of 50° F. to 72° F. In other inventive embodiments, the intermixing of dried mint, dried oregano, or combinations thereof increases the storage stability of chopped fresh parsley to at least 48 hours at a temperature range of 60° F. to 70 F. In still other inventive embodiments, the intermixing of dried mint, dried oregano, or combinations thereof unexpectedly increases the storage stability of chopped fresh parsley to at least 72 hours. It is appreciated that embodiments of the present invention extend the storage stability of chopped fresh parsley 24×, 36×, and in some embodiments in even greater orders of magnitude relative to the standard storage stability of chopped fresh parsley well known in the art—approximately 2 hours.

Prior art solutions employing manufactured absorbent material as a means of reducing available moisture thereby extending storage stability of fresh plant material are well known. Illustratively examples include absorbent pads, desiccant pouches, and the like. However, these prior art solutions do not achieve the storage stability on the orders of magnitude realized in embodiments of the present invention, further highlighting the unexpected observed superior absorbent properties of dried mint, dried oregano, or combinations thereof. It would be expected that absorption of available moisture by any means would yield consistent storage stability results, given that available moisture reduction is achieved regardless of the absorption mechanism. Chopped fresh parsley enrobed in a manufactured absorbent material should exhibit similar storage stability as chopped fresh parsley intermixed with a variety of herbs with similar absorbent properties. However, this is not the case, as embodiments of the present invention exhibit far superior absorption properties relative to prior art solutions. This supports the conclusion that moisture absorption alone is not a determinative factor, and that the moisture absorption medium, is largely dispositive. In fact, according to embodiments of the present invention, it is appreciated the resulting mixture of chopped fresh parsley, dried mint, dried oregano, or combinations thereof is readily stored in the absence of manufactured absorbent material. The unexpected results described herein, and the experimental data described in the examples to follow indicate that the type of moisture absorption medium is largely dispositive as to storage stability extension, and even more particularly, that specific dried herbs such as the dried mint, dried oregano, or combinations thereof operative herein, impart superior moisture absorption properties than that of other herbs and/or manufactured absorbent materials known in the art.

In embodiments of the present invention, the weight ratio of dried mint, dried oregano, or combinations thereof to chopped fresh parsley is between 1:4 and 1:60. In some inventive embodiments, the weight ratio of dried mint, dried oregano, or combinations thereof to chopped fresh parsley is between 1:20 and 1:50. In other inventive embodiments, the weight ratio of dried mint, dried oregano, or combinations thereof to chopped fresh parsley is 1:37.

In some inventive embodiments, the dried mint, dried oregano, or a combination thereof is only dried mint intermixed with the chopped fresh parsley. In other inventive embodiments, the dried mint, dried oregano, or a combination thereof is only dried oregano intermixed with the chopped fresh parsley. It is appreciated that in some inventive embodiments, the resulting mixture of chopped fresh parsley and dried mint, dried oregano, or combinations thereof is a constituent in a tabbouleh salad dish. It is further appreciated that, when included in a tabbouleh salad dish, the resultant mixture extends the storage stability of the tabbouleh salad to at least 48 hours, and in some inventive embodiments beyond 72 hours.

A second process for preserving chopped fresh parsley is also provided and includes intermixing chopped fresh parsley with dried mint at a weight ratio of 1:6-60 dried mint to chopped fresh parsley, absorbing moisture released from the chopped fresh parsley with the dried mint such that the water activity of the mixture is less than 0.90, inhibiting microbial growth, enzymatic browning, or a combination thereof, and extending the storage stability of the chopped fresh parsley to at least 48 hours at a temperature range of between 60° F. to 75° F. In some inventive embodiments, the storage stability of the chopped fresh parsley is extended to at least 72 hours. In some inventive embodiments, the water activity is between 0.65 and 0.85. In still other embodiments, the water activity is between 0.3 and 0.65. It has been surprisingly found that excessively reducing the water activity changes the texture of the chopped parsley or tabbouleh salad.

In other inventive embodiments, the resulting chopped fresh parsley and dried mint mixture is a constituent in tabbouleh salad. In still other inventive embodiments, the resulting mixture is stored in the absence of manufactured absorbent material. The present invention functions to extend the shelf life of chopped fresh parsley without resort to chemical modification such as inclusion of synthetic antioxidants or storage under an atmosphere of carbon dioxide. Conventional antioxidants include ascorbates and phenol derivatives BHA, BHT, TBHQ and propyl gallate. While it is appreciated that the salt, pepper, and lemon juice commonly present in tabbouleh salad have preservative properties, these are not present in recipes in an amount to appreciably extend lifetime in the presence of liquid drawn from chopped parsley and other components of tabbouleh salad.

It is appreciated that the dried mint, dried oregano, or combinations thereof operative herein confer the improved storage stability of chopped fresh parsley as described without negatively affecting desirable qualities of chopped fresh parsley illustratively including flavor profile, color, aroma, and crispy texture. It is further appreciated that the dried mint, dried oregano, or combinations thereof operative herein inhibit microbial load via mechanisms independent of their reduction of A_{w} of chopped fresh parsley. Without intending to be bound by a particular theory, it is believed that dried mint and dried oregano possess inherent antimicrobial properties which operate to limit microbial growth when intermixed with chopped fresh parsley, via mechanisms independent of the reduction in microbial growth conferred via A_{w} reduction.

The present invention is further detailed with respect to the following non-limiting examples and comparatives.

### EXAMPLES

### Example 1

2500 grams of chopped fresh parsley is intermixed with 68 grams of dried mint (weight ratio of 1:37 dried mint to chopped parsley). 800 grams of water is added to the intermixture of 2500 grams of chopped fresh parsley and 68 grams of dried mint and left to saturate for 24 hours. The intermixture is then strained using cheese cloth. 400 grams of water remains after straining. The dried mint is weighed, and weighs 421 grams after straining, thus absorbing 353 grams of water during the 24-hour saturation period. 47 grams of water evaporated and/or was lost in the cheese cloth straining process. The dried mint achieved a 619% water absorption rate after the 24-hour saturation period.

### Example 2

Three test containers were each filled with 300 grams fresh chopped parsley. Test container 1 was then filled with 8 grams of dried cilantro. Test container 2 was then filled with 8 grams dried mint. Test container 3 was then filled with 8 grams dried oregano. All three test containers were then agitated and stored at ambient temperature (67° F.-70° F.). All three test containers were agitated and checked at two-hour intervals for the duration of the test period. At 24.5 hours after initial agitation, the mixture of test container 1 (fresh chopped parsley/cilantro) was already beginning to spoil, while the mixtures of test containers 2 (chopped fresh parsley/dried mint) and 3 (chopped fresh parsley/dried oregano) remained fresh. At 31 hours after initial agitation, the mixture of test container 1 (fresh chopped parsley/cilantro) was spoiled, while the mixtures of test containers 2 (chopped fresh parsley/dried mint) and 3 (chopped fresh parsley/oregano) remained fresh. At 48.5 hours after initial agitation, the mixture of test container 2 (chopped fresh parsley/dried mint) was spoiled, and the mixture of test container 3 (chopped fresh parsley/dried oregano) was beginning to spoil. At 35 hours after initial agitation, the mixture of test container 3 (chopped fresh parsley/oregano) was spoiled.

### Example 3

Example 1 is repeated with 2500 grams of tabbouleh salad including chopped parsley (2200 grams), bulgar (100 grams), tomatoes (100 grams), onion (60 grams), olive oil (20 grams), lemon juice (10 grams), salt (5 grams), and pepper (5 grams) in place of a like amount of chopped parsley. Similar improvements in water absorption were achieved relative to Example 1.

### Example 4

Example 2 is repeated with like amounts of tabbouleh salad per Example 3 in place of a like amount of chopped parsley. Similar improvements in water absorption were achieved relative to Example 2.

While particular embodiments have been described, alternatives, modifications, variations, improvements, and substantial equivalents that are or may be presently unforeseen may arise to applicants or others skilled in the art. Accordingly, the appended claims as filed and as they may be amended, are intended to embrace all such alternatives, modifications variations, improvements, and substantial equivalents. It should also be appreciated that the exemplary embodiment or exemplary embodiments are only examples, and are not intended to limit the scope, applicability, or configuration of the described embodiments in any way. Rather, the foregoing detailed description will provide those skilled in the art with a convenient roadmap for implementing the exemplary embodiment or exemplary embodiments. It should be understood that various changes may be made in the function and arrangement of elements without departing from the scope as set forth in the appended claims and the legal equivalents thereof.

Patent documents and publications mentioned in the specification are indicative of the levels of those skilled in the art to which the invention pertains. These documents and publications are incorporated herein by reference to the same extent as if each individual document or publication was specifically and individually incorporated herein by reference.

1. A process for extending storage stability of chopped fresh parsley or tabbouleh salad comprising:
intermixing chopped fresh parsley or tabbouleh salad with at least one of dried mint, dried oregano, or a combination thereof, where a weight ratio of the dried mint, dried oregano, or a combination thereof to the chopped fresh parsley or tabbouleh salad being between 1:4 and 1:60 to form a mixture;
absorbing moisture released from the chopped fresh parsley with the dried mint, dried oregano, or a combination thereof to extend the storage stability of the chopped fresh parsley or the tabbouleh salad to at least 48 hours at a temperature range of 33° F. to 75° F.

2. The process of claim 1 wherein the at least one of dried mint, dried oregano, or a combination thereof functions in inhibiting microbial growth, enzymatic browning, or a combination thereof.

3. The process of claim 1 wherein only the tabbouleh salad is present.

4. The process of claim 1 wherein only the dried mint is present.

5. The process of claim 1 further comprising extending the storage stability of the chopped fresh parsley to at least 48 hours at a temperature range of 50° F. to 72° F.

6. The process of claim 1 further comprising extending the storage stability of the chopped fresh parsley to at least 48 hours at a temperature range of 60° F. to 70° F.

7. The process of claim 1 further comprising extending the storage stability of the chopped fresh parsley to at least 72 hours at a temperature range of 60° F. to 70° F.

8. The process of claim 1 wherein the water activity of the mixture is between 0.65 and 0.9.

9. The process of claim 1 wherein the water activity of the mixture is between 0.3 and 0.65.

10. The process of claim 1 wherein the at least one of dried mint, dried oregano, or a combination thereof is dried mint.

11. The process of claim 1 wherein the at least one of dried mint, dried oregano, or a combination thereof is dried oregano.

13. The process of claim 1 further comprising storing the mixture in the absence of synthetic antioxidants or carbon dioxide.

14. The process of claim 1 wherein synthetic antioxidants comprise ascorbates and phenol derivatives BHA, BHT, TBHQ and propyl gallate.

15. The process of claim 1 further comprising storing the mixture in the absence of thermal and chemical adulterants.

16. The process of claim 15 wherein the thermal and chemical adulterants comprise heating, freezing, drying, adding oils, salts, chemical oxygen scavengers, chemical desiccants, and chemical wetting agents.

17. The process of claim 1 wherein the weight ratio of dried mint, dried oregano, or combinations thereof to chopped fresh parsley is between 1:20 and 1:50.

18. The process of claim 1 wherein the weight ratio of dried mint, dried oregano, or combinations thereof to chopped fresh parsley is 1:37.

19. A composition comprising:
chopped fresh parsley or tabbouleh salad;
dried mint, dried oregano, or a combination thereof in a weight ratio of the dried mint, dried oregano, or a combination thereof to the chopped fresh parsley or tabbouleh salad of between 1:25 and 1:60 to form a mixture.

20. The composition of claim 19 wherein the storage stability of the chopped fresh parsley or the tabbouleh salad is at least 48 hours at a temperature range of 33° F. to 75° F.
